(19) United States
(12) Patent Application Publication
(10) Pub. No.: US 2026/0074507 A1
(43) Pub. Date: Mar. 12, 2026

(54) ELECTRONIC DEVICE FOR DIAGNOSING POWER FAILURE OF DISPLAY AND OPERATING METHOD THEREOF

(71) Applicant: Samsung Electronics Co., Ltd., Suwon-si (KR)

(72) Inventors: Jungwoo LEE, Suwon-si (KR); Kihwan CHEONG, Suwon-si (KR); Byungchul CHOI, Suwon-si (KR)

(21) Appl. No.: 19/388,371

(22) Filed: Nov. 13, 2025

Related U.S. Application Data
(63) Continuation of application No. PCT/KR2024/004656, filed on Apr. 8, 2024.

(30) Foreign Application Priority Data
May 16, 2023 (KR) 10-2023-0063143
Jun. 8, 2023 (KR) 10-2023-0073723

(51) Int. Cl. H02H 7/00

(52) U.S. Cl. CPC H02H 7/008

(57) ABSTRACT

An electronic device is provided. The electronic device includes at least one processor, memory, comprising one or more storage media, storing instructions, a display module, a first power management module for controlling a first voltage power supply and a second voltage power supply provided to the display module, and a second power management module including a regulator power supply and controlling power supplied to at least one processor, wherein the instructions, when executed by the at least one processor individually or collectively, cause the electronic device to while the first voltage power supply is turned on, switch a first mode in which the regulator power supply is operating to a second mode in which the regulator power supply operates as a bypass, receive an interrupt generated based on a first voltage outputted by the first voltage power supply, and determine an abnormality of the display module based on the interrupt.

### CROSS-REFERENCE TO RELATED APPLICATION(S)

This application is a continuation application, claiming priority under 35 U.S.C. § 365 (c), of an International application No. PCT/KR2024/004656, filed on Apr. 8, 2024, which is based on and claims the benefit of a Korean patent application number 10-2023-0063143, filed on May 16, 2023, in the Korean Intellectual Property Office, and of a Korean patent application number 10-2023-0073723, filed on Jun. 8, 2023, in the Korean Intellectual Property Office, the disclosure of each of which is incorporated by reference herein in its entirety.

### BACKGROUND

### 1. Field

The disclosure relates to a technique for diagnosing a power failure of a display in an electronic device.

### 2. Description of Related Art

As a function of a mobile device becomes diverse, a type of a failure therein is also diversified. Among various types of the failure, a failure occurring in a display, which is intuitively recognized by a user, may cause relatively greater inconvenience, and may provide visual and operational inconvenience in a smartphone of which a surface area mostly is configured with the display.

There may be several causes of the display failure, including a material failure, a failure due to external impact and a progressive failure. Among them, the progressive failure may be caused by a foreign substance or corrosion inside the mobile device.

As for the progressive failure, the user may visually identify the display failure while using the mobile device.

However, if display power has a problem of the progress failure, which is not directly visually presented on a display screen, the user may not immediately identify it with the naked eye, and it may, if left unattended, have a negative effect not only on the display but also on other component.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for detecting a failure of a display module in advance even while a display screen normally operates and an operating method thereof.

Additional aspects will be set forth in part in the description which follows and, in part, will be apparent from the description, or may be learned by practice of the presented embodiments.

In accordance with an aspect of the disclosure, an electronic device is provided. The electronic device includes at least one processor, memory, comprising one or more storage media, storing instructions, a display module, a first power management module for controlling a first voltage power supply and a second voltage power supply provided to the display module, and a second power management module including a regulator power supply and controlling power supplied to the at least one processor, wherein the instructions, when executed by the at least one processor individually or collectively, cause the electronic device to, while the first voltage power supply is turned on, switch a first mode in which the regulator power supply is operating to a second mode in which the regulator power supply operates as a bypass, receive an interrupt generated based on a first voltage outputted by the first voltage power supply, and determine an abnormality of the display module based on the interrupt.

In accordance with another aspect of the disclosure, an operating method of an electronic device which includes a display module, a first power management module, a second power management module, and at least one processor is provided. The operating method includes, while a first voltage power supply controlled by the first power management module is turned on, switching a first mode in which a regulator power supply of the second power management module is operating to a second mode in which the regulator power supply operating as a bypass, receiving, at the at least one processor, an interrupt generated based on a first voltage outputted by the first voltage power supply, and determining an abnormality of the display module based on the interrupt.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include while a first voltage power supply controlled by a first power management module is turned on, switching a first mode in which a regulator power supply of a second power management module is operating to a second mode in which the regulator power supply is operating as a bypass, receiving, at the at least one processor, an interrupt generated based on a first voltage outputted by the first voltage power supply, and determining an abnormality of the display module based on the interrupt.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device within a network environment according to an embodiment of the disclosure;

FIG. 2 is a block diagram of a display module according to an embodiment of the disclosure;

FIG. 3 illustrates voltage power supplies between a display module and a display power management module according to an embodiment of the disclosure;

FIG. 4 illustrates a connection structure between a display module and a display power management module according to an embodiment of the disclosure;

FIG. 5 illustrates a control block diagram if no short circuit occurs in a display module according to an embodiment of the disclosure;

FIG. 6 is a flowchart of an operating method of an electronic device in a state shown in FIG. 5 according to an embodiment of the disclosure;

FIG. 7 illustrates a control block diagram if a short circuit occurs in a display module according to an embodiment of the disclosure;

FIG. 8 is a diagram for explaining a voltage drop if a short circuit occurs in a display module according to an embodiment of the disclosure;

FIG. 9 is a flowchart of an operating method of an electronic device in a state shown in FIG. 8 according to an embodiment of the disclosure;

FIG. 10 is a flowchart of an operating method of an electronic device according to an embodiment of the disclosure; and

FIG. 11 is a flowchart of an operating method of an electronic device for using various diagnostic modes according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include the plural referents unless the context clearly dictates otherwise. Thus, for example, reference to “a component surface” includes reference to one or more of such surfaces.

“Comprises” and/or “comprising,” as used in the specification do not exclude presence or addition of one or more other components, steps, operations and/or elements thereof.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

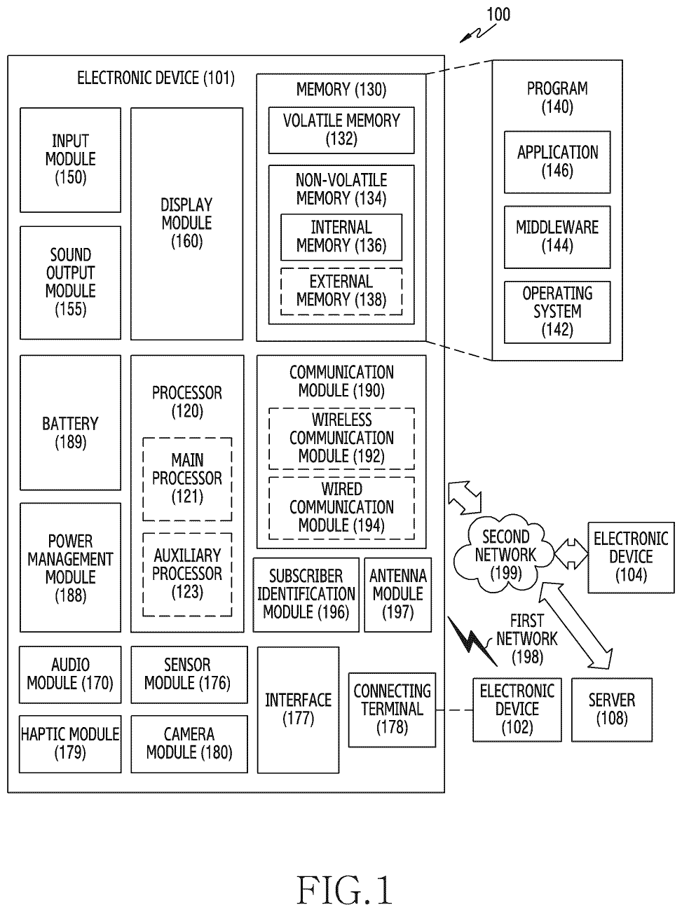

FIG. 1 is a block diagram illustrating an electronic device #01 in a network environment #00 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device #01. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal #78 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mm Wave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mm Wave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device #01 may be executed at one or more of the external electronic devices 102 or 104, or server 108. For example, if the electronic device #01 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

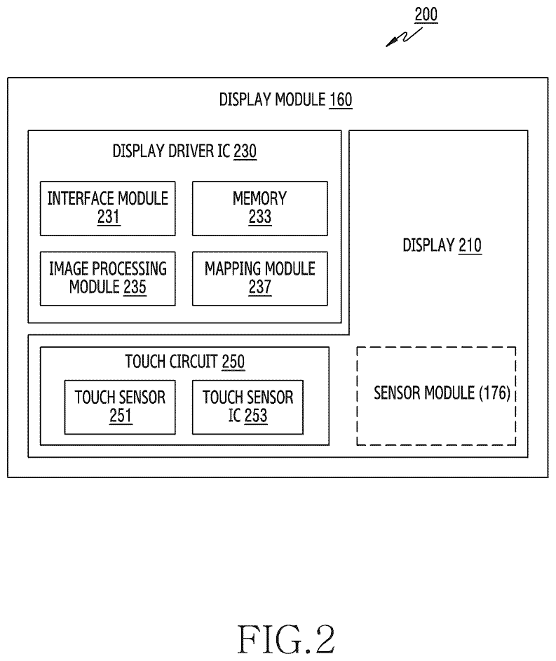

FIG. 2 is a block diagram of a display module according to an embodiment of the disclosure.

Referring to FIG. 2, a block diagram 200 of a display module 160 may include a display 210 and a display driver IC (DDI) 230 for controlling the same. The DDI 230 may include an interface module 231, memory 233 (e.g., buffer memory), an image processing module 235, or a mapping module 237. The DDI 230 may receive image information including, for example, image data or an image control signal corresponding to a command for controlling the image data, from another component of the electronic device 101 through the interface module 231. For example, according to an embodiment, the image information may be received from the processor 120 (e.g., the main processor 121 (e.g., an application processor) or the auxiliary processor 123 (e.g., a graphic processing unit) operated independently of the function of the main processor 121). The DDI 230 may communicate with a touch circuit 250 or a sensor module 176 through the interface module 231. In addition, the DDI 230 may store at least a part of the received image information in the memory 233, for example, on a frame basis. The image processing module 235 may perform, for example, preprocessing or postprocessing (e.g., resolution, brightness, or size adjustment) on at least a part of the image data based on at least characteristics of the image data or characteristics of the display 210. The mapping module 237 may generate a voltage value or a current value corresponding to the image data preprocessed or postprocessed through the image processing module 135. According to an embodiment, generating the voltage value or the current value may be performed based at least in part on, for example, properties of pixels of the display 210 (e.g., arrangement of pixels (a red, green, and blue (RGB) stripe or pentile structure), or size of each of sub-pixels). At least some pixels of the display 210 may be driven at least in part based on, for example, the voltage value or the current value, and accordingly visual information (e.g., a text, an image, or an icon) corresponding to the image data may be displayed through the display 210.

According to an embodiment, the display module 160 may further include the touch circuit 250. The touch circuit 250 may include a touch sensor 251 and a touch sensor IC 253 for controlling the same. The touch sensor IC 253 may, for example, control the touch sensor 251 to detect a touch input or a hovering input for a specific position of the display 210. For example, the touch sensor IC 253 may detect the touch input or the hovering input by measuring a change in a signal (e.g., a voltage, a light amount, resistance, or a charge amount) for the specific position of the display 210. The touch sensor IC 253 may provide the processor 120 with information (e.g., a position, an area, a pressure, or time) of the detected touch input or hovering input. According to an embodiment, at least a part (e.g., the touch sensor IC 253) of the touch circuit 250 may be included as a part of the display driver IC 230, or as a part of the display 210, or as a part of other component (e.g., the auxiliary processor 123) disposed outside the display module 160.

According to an embodiment, the display module 160 may further include at least one sensor (e.g., a fingerprint sensor, an iris sensor, a pressure sensor or an illuminance sensor) of the sensor module 176, or a control circuit therefor. In this case, the at least one sensor or the control circuit therefor may be embedded in a part of the display module 160 (e.g., the display 210 or the DDI 230) or a part of the touch circuit 250. For example, if the sensor module 176 embedded in the display module 160 includes a biometric sensor (e.g., a fingerprint sensor), the biometric sensor may obtain biometric information (e.g., a fingerprint image) associated with a touch input through some region of the display 210. As another example, if the sensor module 176 embedded in the display module 160 includes a pressure sensor, the pressure sensor may obtain pressure information associated with a touch input through a partial or whole region of the display 210. According to an embodiment, the touch sensor 251 or the sensor module 176 may be disposed between pixels of a pixel layer of the display 210, or above or below the pixel layer.

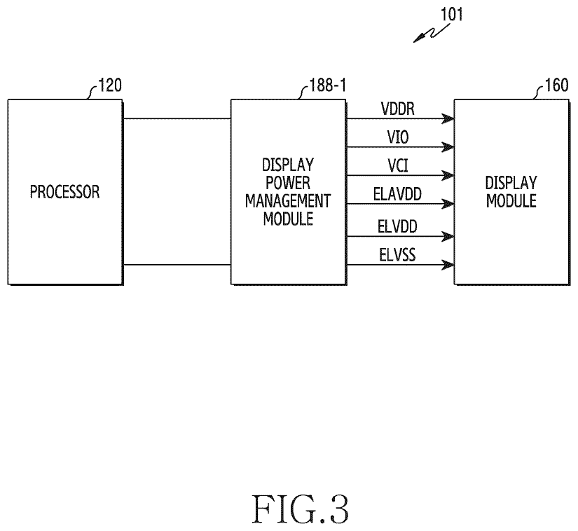

FIG. 3 illustrates voltage power supplies between a display module and a display power management module according to an embodiment of the disclosure.

The display module 160 according to an embodiment may include an organic light emitting diodes (OLED) panel to visually provide information to an outside (e.g., a user) of the electronic device 101. In addition to the OLED panel, the display module 160 may include various types of the display panel such as a liquid crystal display (LCD) panel, a plasma display panel (PDP) panel, an inorganic LED panel, a micro LED panel, but is not limited thereto.

A display power management module 188-1 may be a power management integrated circuit (PMIC) as a chip for controlling power supplied to the display module 160. The display power management module 188-1 may receive a control signal from the processor 120 and control the operation of the display module 160 and the power supplied to the display module 160.

The display power management module 188-1 may supply a power voltage to a plurality of pixels through wires, and control to supply power voltages having different levels to a plurality of elements respectively included in the display module 160 via the plurality of wires. For example, the display power management module 188-1 may control to supply voltages having different levels to the display DDI 230 (see FIG. 2) included in the display module 160 and a panel (not shown) included in the display module 160.

Meanwhile, as shown in FIG. 3, the display power management module 188-1 may include the plurality of wires to independently provide the voltage required for each element included in the display module 160. The plurality of wires may supply the same or different voltages such as a first voltage, a second voltage, and a third voltage, to the display module 160.

Among the supplied power of the display module 160 according to an embodiment, VDDR is power supplied to the display DDI 230 (see FIG. 2) of the display module 160 through the first power management module 188-1, and corresponds to a power supply for logic and memory blocks. For example, the voltage supplied from the VDDR may be about 1.6V.

Among the supplied power of the display module 160 according to an embodiment, VIO is power supplied to the display DDI 230 (see FIG. 2) of the display module 160 through the first power management module 188-1, and corresponds to a power supply for an input/output (I/O) interface and a mobile industry processor interface (MIPI) interface. For example, the voltage supplied from the VIO may be about 1.8V.

Among the supplied power of the display module 160 according to an embodiment, VCI is power supplied to the display DDI 230 (see FIG. 2) of the display module 160 through the first power management module 188-1, and corresponds to an analog driving power supply of DDI. For example, the voltage supplied from the VCI may be about 3V.

Among the supplied power of the display module 160 according to an embodiment, ELAVDD is power supplied to the display DDI 230 (see FIG. 2) of the display module 160 through the first power management module 188-1, and corresponds to an input power supply of power generation circuits. For example, the power generation circuits may include a DC/DC charge pump, an oscillator, a voltage divider circuit, a reference voltage generation circuit and/or a regulator. For example, the voltage supplied from ELAVDD may be about 7.2V, which may be the highest value among the voltages supplied to various elements configuring the display module 160.

Among the supplied power of the display module 160 according to an embodiment, ELVDD may correspond to driving power supplied to the panel through the first power management module 188-1. ELVDD corresponds to a power supply required to supply the current to the OLED, and may have a voltage relatively higher than the voltage supplied to DDI. For example, the voltage supplied from ELVDD may be about 4.6V.

Among the supplied power of the display module 160 according to an embodiment, ELVSS may correspond to driving power supplied to the panel through the first power management module 188-1. ELVDD corresponds to the power required to supply the current to the OLED, and may have a voltage relatively lower than the voltage supplied to DDI. For example, the voltage supplied from ELVSS may be about −4.4V.

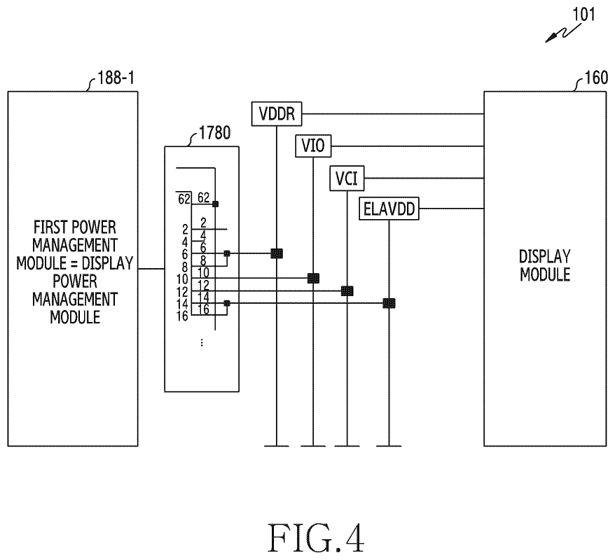

FIG. 4 illustrates a connection structure between a display module and a display power management module (hereafter referred to as the first power management module 188-1) according to an embodiment of the disclosure.

Referring to FIG. 4, the connection structure with a plurality of wires between the first power management module 188-1 and the display module 160 shall be described in more detail.

The first power management module 188-1 according to an embodiment may include or be connected to a connector 1780. The connector 1780 may include a plurality of pins, and each pin may be connected to the display module 160 through a different wire. For example, the connector 1780 may include 60 pins, but may include fewer or more pins than 60 pins depending on a wiring design between the first power management module 188-1 and the display module 160.

The power supply having the highest voltage is EVAVDD among the illustrated power supplies and, for example, EVAVDD may provide a voltage of about 7.2V to the display module 160. VCI, which is a power supply adjacent to ELAVDD, is a power supply supplied to the DDI and may provide a voltage of about 3.0V to the display module 160. At this time, ELAVDD and VCI are closest in terms of relative positions, and a problem may occur in a resistive material near the wire transmitting the voltage of ELAVDD due to the high voltage characteristic of ELAVDD. Hence, a short circuit may occur between ELAVDD and VCI. Meanwhile, even if the short circuit occurs between ELAVDD and VCI, it is not visually identified in an image provided on the display screen, but if the short circuit state is maintained and a voltage not meeting rated specifications is continuously applied to each element included in the display module 160, other component may be damaged in addition to the display module 160.

As above, the short circuit occurring between ELAVDD and VCI has been described, but it is not necessarily limited to ELAVDD and VCI. If ELAVDD, which has the highest voltage, is positioned close to or electrically connected to ELAVDD through the wire, a short circuit may also occur in other power wire in relation to ELAVDD.

Meanwhile, the first power management module 188-1 may operate according to a first mode or a second mode.

The first mode indicates a state in which the user is using an application of the electronic device 101, and the processor 120, the display module 160 and the network operate normally. For example, in the first mode, the first power management module 188-1 may operate in a buck mode to supply the rated voltage to the display module 160.

The second mode corresponds to a mode for reducing battery consumption by delaying the operation of the processor 120, the operation of the display module 160 and the operation of the network, if the user does not use the electronic device 101 for a specific period of time. For example, the electronic device 101 operates in a doze mode which is the second mode, if a set time elapses with the screen turned off while not being charged. If the electronic device 101 enters the second mode, the first power management module 188-1 for managing the power supplied to the display module 160 and/or the second power management module 188-2 for managing the power supplied to the processor 120 may operate according to the doze mode to reduce the power consumption in the operation of the processor 120 and/or the display module 160.

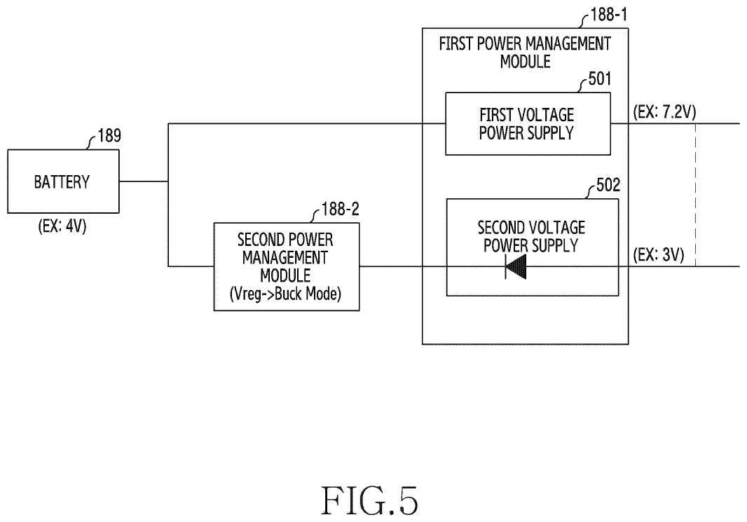

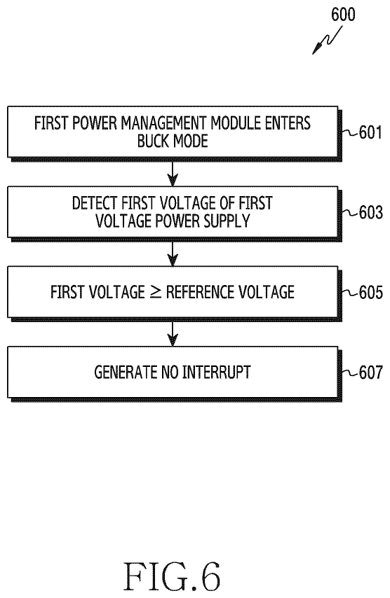

FIG. 5 illustrates a control block diagram if a short circuit does not occur according to an embodiment of the disclosure, and FIG. 6 is a flowchart of an operating method of an electronic device in the state shown in FIG. 5 according to an embodiment of the disclosure.

The first power management module 188-1 according to an embodiment causes a first voltage power supply 501 to supply a first voltage, and to supply a second voltage lower than the first voltage to the display module 160 (FIG. 4) in the first mode. The battery 189 supplies the power to the display module 160, the first power management module 188-1 which manages the power to be supplied to the display module 160, and the second power management module 188-2 which manages the power supplied to the processor 120. In the first mode, the second power management module 188-2 operates in the buck mode to allow the application to be executed normally.

For example, if the first voltage power supply is ELAVDD and the second voltage power supply is VCI, ELAVDD may supply a voltage of about 7.2V to the display module 160 to the regulator of the display module 160, and VCI may supply a voltage of about 3V to the display DDI 230 (see FIG. 2) to the display module 160.

Referring to FIG. 6, a method 600 performed by the electronic device 101 according to an embodiment causes the first power management module 188-1 to enter the first mode in operation 601.

In the first mode, the first voltage power supply 501 supplies the first voltage not exceeding absolute maximum ratings (AMR) to the display module 160. In the second mode, the second voltage power supply 502 supplies the second voltage not exceeding the AMR to the display module 160. The first voltage corresponds to a voltage higher than the second voltage.

The electronic device 101 according to an embodiment may detect the first voltage outputted from the first voltage power supply 501 in operation 603.

The electronic device 101 according to an embodiment determines whether the first voltage outputted from the first voltage power supply 501 is equal to or higher than a reference voltage in operation 605. The reference voltage is a value compared to determine whether a voltage drop occurs in the first voltage due to the short circuit, is lower than a maximum rated voltage, and indicates a voltage level if the first voltage power supply normally supplies the power.

According to operation 605, if the first voltage is equal to the reference voltage or lower than the maximum rated voltage, the electronic device 101 according to an embodiment determines no short circuit occurred.

Next, the electronic device 101 according to an embodiment does not generate an interrupt in operation 607. The interrupt may correspond to one of routine operations processed for short circuit protection (SCP) provided by the first power management module 188-1.

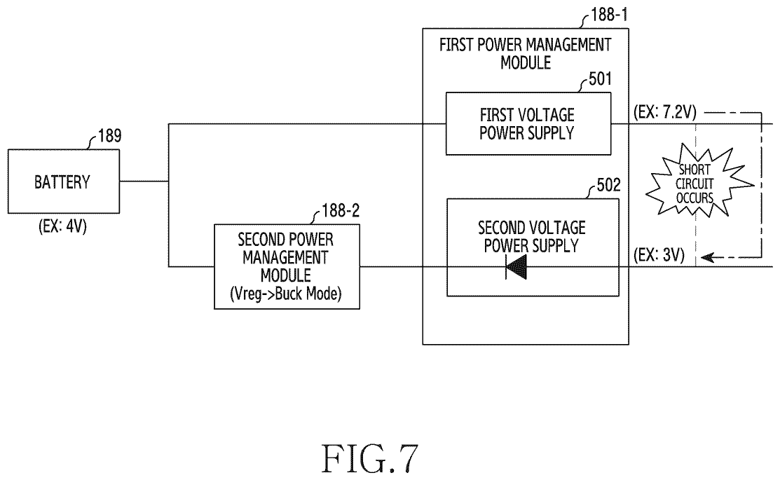

FIG. 7 illustrates a control block diagram if a short occurs in a first mode according to an embodiment of the disclosure.

Unlike FIG. 5, if a short circuit occurs between the first voltage power supply 501 and the second voltage power supply 502, the first voltage supplied from the first voltage power supply 501 may be applied to an output terminal of the second voltage power supply 502.

For example, if the first voltage power supply 501 is ELAVDD, it outputs the voltage of about 7.2V. If a short circuit occurs, the voltage of 7.2V may be also supplied to an element corresponding to the second voltage power supply 502. As mentioned above, ELAVDD is the power supply for supplying the highest voltage in the relationship between the display module 160 and the first power management module 188-1, and if the voltage supplied by ELAVDD is supplied to other element than the element corresponding to ELAVDD, it may cause component damage because it exceeds the maximum rated voltage.

In addition, in the short circuit condition, the first voltage supplied from the first voltage power supply 501 may be applied to the second power management module 188-2 due to diode characteristics of the second voltage power supply 502, and as a result, the second power management module 188-2 may be also adversely affected.

Even if the short circuit occurs in the electronic device 101, the voltage of a specific level, which is not at the rated voltage of the display module 160, is supplied to each element, and accordingly the user may not identify the power failure on the display screen.

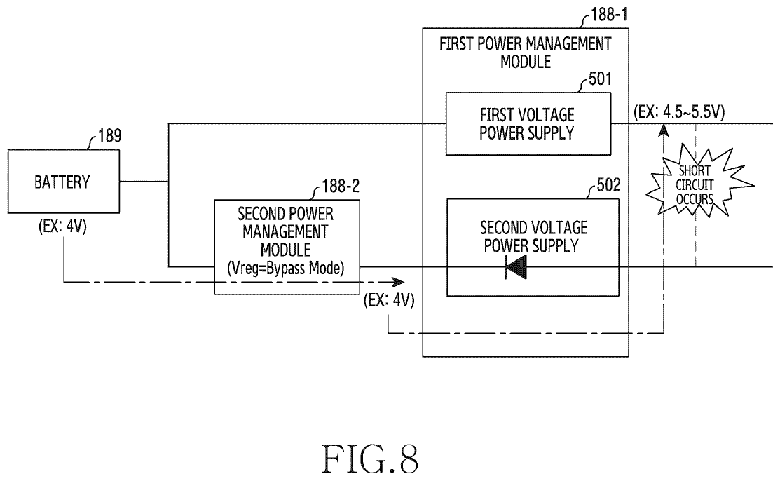

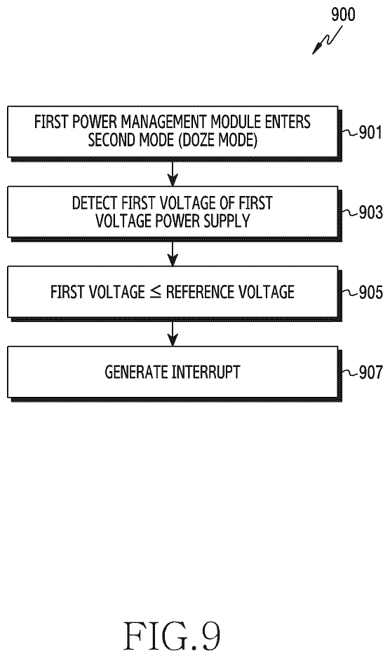

FIG. 8 is a diagram for explaining a voltage drop if a short circuit occurs in a second mode according to an embodiment of the disclosure. FIG. 9 is a flowchart of an operating method of an electronic device in the state shown in FIG. 8 according to an embodiment of the disclosure.

The electronic device 101 according to an embodiment may switch the power management module 188 (see FIG. 1) from the first mode to the second mode. The first mode is the state in which the user is using an application of the electronic device 101, and the power may be supplied in a designated manner to normally operate the processor 120, the display module 160 and the network. The second mode may correspond to the state for minimizing the consumption of the battery 189 if the user does not use the electronic device 101 for a specific time. That is, the electronic device 101 according to an embodiment may switch the power management module 188 from the first mode to the second mode even if the user is using the application.

According to an embodiment, the electronic device 101 may control the second power management module 188-2 in the second mode to operate a regulator power supply Vreg of the second power management module 188-2 in a bypass mode. If the regulator power supply operates in the bypass mode, the power supplied from the battery 189 may pass through the second power management module 188-2 and be applied between the second power management module 188-2 and the second voltage power supply 502. For example, if the voltage outputted by the battery 189 in the second mode is 4V, the voltage of 4V may pass through the second power management module 188-2 and be applied between the second power management module 188-2 and the second voltage power supply 502. At this time, the voltage of 4V passing through the second power management module 188-2 may be also applied to the second voltage power supply 502, and a voltage lower than 4V is also transmitted to the output terminal of the first voltage power supply 501 due to resistance of the diode. That is, a voltage drop occurs at the output terminal of the first voltage power supply 501.

The first power management module 188-1 according to an embodiment may generate an interrupt which is the routine operation processed for the SCP. The first power management module 188-1 according to an embodiment may generate the interrupt if detecting a voltage lower than the reference voltage at the output terminal of the first voltage power supply 501.

Referring to FIG. 9, a method 900 performed by the electronic device 101 according to an embodiment causes the first power management module 188-1 to enter the second mode from the first mode in operation 901. If the electronic device 101 according to an embodiment is in the second mode, the regulator power supply Vreg of the second power management module 188-2 may operate in the bypass mode. Hence, the power supplied from the battery 189 may be applied between the second power management module 188-2 and the second voltage power supply 502 by passing through the second power management module 188-2.

The electronic device 101 according to an embodiment may detect the first voltage outputted from the first voltage power supply 501 in operation 903.

Unlike the cases of FIGS. 5 and 6, in the embodiment according to FIG. 9, the short circuit may occur between the first voltage power supply 501 and the second voltage power supply 502 and the voltage drop may occur at the output terminal of the first power supply voltage 501.

The electronic device 101 according to an embodiment determines whether the first voltage outputted from the first voltage power supply 501 is lower than the reference voltage in operation 905. In the short circuit condition, the first voltage may be lower than a voltage normally outputted. For example, if the regulator power supply Vreg operates as the bypass, the voltage outputted from the battery 189 is transmitted to the output terminal of the first voltage power supply 501 by passing through the second voltage power supply 502. At this time, the transmitted voltage drops the first voltage supplied from the first voltage power supply 501.

According to operation 905, if the first voltage is lower than the reference voltage, the electronic device 101 according to an embodiment determines that the short circuit occurs.

Next, the electronic device 101 according to an embodiment generates the interrupt in operation 907. The first power management module 188-1 according to an embodiment transmits the interrupt to the processor 120 (FIG. 1).

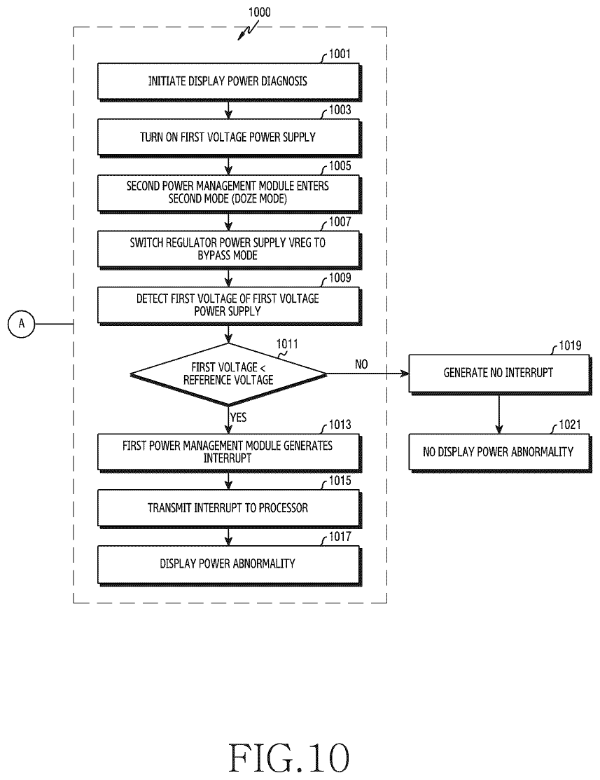

FIG. 10 is a flowchart of an operating method of an electronic device according to an embodiment of the disclosure.

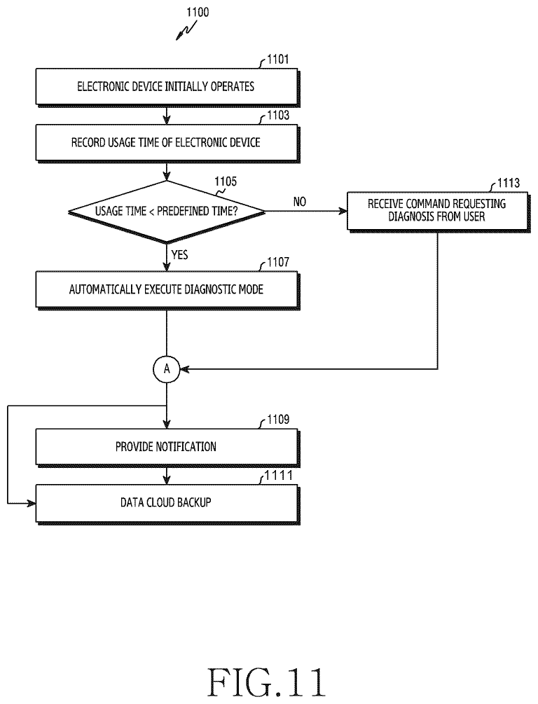

Referring to FIG. 10, a method 1000 performed by the electronic device 101 according to an embodiment initiates a display power diagnosis (a diagnosis mode) in operation 1001. The diagnosis mode may be conducted at a user's command or automatically. The diagnosis mode may be performed automatically if various conditions are satisfied. The various conditions shall be described in detail with reference to FIG. 11.

The electronic device 101 according to an embodiment may turn on the first voltage power supply 501 in operation 1003. The processor 120 may control the first power management module 188-1 to turn on the first voltage power supply 501. The reason for turning on the first voltage power supply 501 is that an interrupt generation condition is a voltage drop occurring at the output terminal of the first voltage power supply 501.

The electronic device 101 according to an embodiment may cause the second power management module 188-2 to enter the second mode in operation 1005.

The electronic device 101 according to an embodiment controls the second power management module 188-2 to operate the regulator power supply Vreg in the bypass mode in operation 1007.

The electronic device 101 according to an embodiment detects the first voltage of the first voltage power supply 501 in operation 1009. The first voltage generated at the output terminal of the first voltage power supply 501 may be lowered due to the short circuit occurrence.

If the first voltage is lower than the reference voltage 1011, the first power management module 188-1 according to an embodiment generates an interrupt in operation 1013. Next, the first power management module 188-1 according to an embodiment transmits the interrupt to the processor 120 in operation 1015.

According to an embodiment, if receiving the interrupt, the processor 120 determines an abnormality in the display power in operation 1017.

Meanwhile, if the first voltage is not smaller than the reference voltage and is close to the rated voltage, the first power management module 188-1 according to an embodiment does not generate an interrupt in operation 1019.

If no interrupt is generated, the electronic device 101 according to an embodiment determines no abnormality with the display power in operation 1021.

As above, the algorithm for detecting the abnormality of the display power supply based on the voltage drop due to the short circuit occurrence and the interrupt due to the voltage drop has been explained. In the following, a solution for the electronic device 101 to perform the diagnostic mode according to various conditions and deal with an abnormality if discovering the abnormality of the display power supply as a result of the diagnostic mode shall be described.

FIG. 11 is a flowchart of an operating method of an electronic device for using various diagnostic modes according to an embodiment of the disclosure.

Referring to FIG. 11, a method 1100 performed by the electronic device 101 initially operates according to an embodiment in operation 1101, the electronic device 101 records the usage time of the electronic device 101 after its operation in operation 1103. Once a short circuit occurs, damage caused by the short circuit occurrence accumulates over the usage time, and accordingly the electronic device 101 records the usage time accumulated from the usage start of the user after purchasing the electronic device 101.

A predefined time may be set differently for each region of the electronic device 101. Durability of the electronic device 101 may be affected by a temperature or a humidity of the specific region. For example, if the region where the electronic device 101 is used is in a high temperature and high humidity environment, a short circuit may occur easily or component damage caused by the short circuit may occur relatively fast.

If the recorded usage time exceeds the predefined time in operation 1105, the electronic device 101 automatically executes the diagnostic mode in operation 1107. If the diagnostic mode is automatically executed, operations according to FIG. 10 may be performed.

Even if the usage time does not exceed the predefined time, the electronic device 101 according to an embodiment may perform the diagnostic mode, by receiving a command requesting the diagnosis from the user in operation 1113.

In addition, if abnormal rebooting occurs, the electronic device 101 according to an embodiment may automatically perform the diagnostic mode, without receiving the command requesting the diagnosis from the user.

Further, the electronic device 101 according to an embodiment may automatically perform the diagnostic mode in response to receiving a command from the user to forcibly terminate the electronic device 101 and receiving a command from the user to reboot the electronic device 101.

Meanwhile, if the electronic device 101 according to an embodiment performs the diagnostic mode and discovers an abnormality in the display power, it may provide a notification of the display power abnormality in operation 1109. For example, the electronic device 101 may output a pop-up on the display screen to provide the user with a message requiring additional diagnosis. In addition, the electronic device 101 according to an embodiment may provide the notification to the external electronic device 102 or 104 or server 108 (see FIG. 1) through a wireless communication channel, in addition to providing the notification on the display screen. For example, the electronic device 101 may control the communication module 190 (see FIG. 1) to provide the notification to a wearable device (e.g., a smart watch) connected using Bluetooth. In addition, for example, the electronic device 101 may control the communication module 190 (see FIG. 1) to provide the notification to the external electronic device 104 (see FIG. 1) linked to an internet of things platform. Further, if performing the diagnostic mode and discovering an abnormality in the display power, the electronic device 101 according to an embodiment may execute a data cloud backup of all data stored in the electronic device 101 in operation 1111.

The electronic device 101 according to an embodiment may automatically perform the data cloud backup, and may provide the user with a message notifying of the display power the user and concurrently provide a message suggesting the data cloud backup due to the display power abnormality.

An electronic device 101 (FIG. 1) according to an embodiment may include a display module 160 (FIGS. 1 to 4), a first power management module 188-1 (FIGS. 3 to 5, 7, and 8) for controlling a first voltage power supply 501 (FIGS. 5, 7, and 8) and a second voltage power supply 502 (FIGS. 5, 7, and 8) provided to the display module (FIGS. 1 to 4), and a second power management module 188-2 (FIGS. 5, 7, and 8) including a regulator power supply Vreg (FIGS. 5, 7, and 8) and controlling power supplied to at least one processor 120 (FIGS. 1 and 3). The at least one processor 120 (FIGS. 1 and 3) according to an embodiment may, while the first voltage power supply 501 (FIGS. 5, 7, and 8) is turned on, switch a first mode in which the regulator power supply (FIGS. 5, 7, and 8) is operating to a second mode in which the regulator power supply (FIGS. 5, 7, and 8) operates as a bypass. The at least one processor 120 (FIGS. 1 and 3) according to an embodiment may receive an interrupt generated based on a first voltage outputted by the first voltage power supply 501 (FIGS. 5, 7, and 8). The at least one processor 120 (FIGS. 1 and 3) according to an embodiment may determine an abnormality of the display module 160 (FIGS. 1 to 4) based on the interrupt.

The electronic device 101 (FIG. 1) according to an embodiment may further include a connector 1780 (FIG. 4) including a plurality of pins to electrically connect the display module 160 and the first power management module 188-1. The first voltage power supply 501 and the second voltage power supply 502 according to an embodiment may provide power to the display module 160 at positions of adjacent pins among the plurality of pins. The first power management module 188-1 according to an embodiment may generate the interrupt, if the first voltage falls below a reference voltage due to a short circuit occurring between the first voltage power supply 501 and the second voltage power supply 502.

The at least one processor 120 according to an embodiment may receive the interrupt from the first power management module 188-1. The interrupt may be SCP provided by the first power management module 188-1.

The first voltage power supply 501 according to an embodiment may be ELAVDD for providing a first voltage which is an input power to a power generation circuit through the first power management module 188-1. The second voltage power supply 502 according to an embodiment may be VCI for providing a second voltage which is a driving power supply to a display driver IC 230 (FIG. 2) through the first power management module 188-1, and the second voltage may be lower than the first voltage.

If receiving the interrupt, the at least one processor 120 according to an embodiment may determine power failure of the display module 160, and control the display module 160 to output power status information of the display module 160 on a screen.

The electronic device 101 (FIG. 1) according to an embodiment may further include memory 130 (FIG. 1) operatively connected to the at least one processor 120. The memory 130 according to an embodiment may store a time at which the interrupt generates in a diagnostic mode in which the first mode is switched to the second mode.

The at least one processor 120 according to an embodiment may cause the memory 130 to record a usage time of the electronic device 101. The at least one processor 120 according to an embodiment may automatically execute the diagnostic mode, if the usage time exceeds a predefined time.

The at least one processor 120 according to an embodiment may execute the diagnostic mode, if receiving a command requesting a diagnostic from a user.

The electronic device 101 (FIG. 1) according to an embodiment may further include a communication module 190 (FIG. 1) for communicating with an external device 102 or 104 or server 108 of FIG. 1 over a network. If receiving the interrupt, the at least one processor 120 according to an embodiment may transmit data stored in the memory to the external device 102 or 104 or server 108 of FIG. 1 over the network.

The predefined time according to an embodiment may be set differently for each region of the electronic device 101.

In an operating method of an electronic device 101 (FIG. 1) according to an embodiment, the electronic device 101 may include a display module 160 (FIG. 1 through FIG. 4), a first power management module 188-1 (FIGS. 3 to 5, 7, and 8), a second power management module 188-2 (FIGS. 5, 7, and 8) and at least one processor 120 (FIGS. 1 and 3). The operating method according to an embodiment may include, while a first voltage power supply 501 (FIGS. 5, 7, and 8) controlled by the first power management module 188-1 is turned on, switching a first mode in which a regulator power supply Vreg (FIGS. 5, 7, and 8) of the second power management module 188-2 (FIGS. 5, 7, and 8) is operating to a second mode in which the regulator power supply Vreg operates as a bypass. The operating method according to an embodiment may include receiving, at the at least one processor 120, an interrupt generated based on a first voltage outputted by the first voltage power supply 501. The operating method according to an embodiment may include determining an abnormality of the display module 160 based on the interrupt.

The electronic device 101 (FIG. 1) according to an embodiment may further include a connector 1780 (FIG. 4) including a plurality of pins to electrically connect the display module 160 and the first power management module 188-1. The first voltage power supply 501 and the second voltage power supply 502 according to an embodiment may provide power to the display module 160 at positions of adjacent pins among the plurality of pins. The operating method according to an embodiment may further include generating, at the first power management module 188-1, the interrupt, if the first voltage falls below a reference voltage due to a short circuit occurring between the first voltage power supply 501 and the second voltage power supply 502.

The operating method according to an embodiment may further include receiving, at the at least one processor 120, the interrupt from the first power management module 188-1. The interrupt according to an embodiment may be SCP provided by the first power management module 188-1.

The first voltage power supply 501 according to an embodiment may be ELAVDD for providing a first voltage which is an input power to a power generation circuit through the first power management module 188-1. The second voltage power supply 502 according to an embodiment may be VCI for providing a second voltage which is a driving power supply to a display driver IC 230 (FIG. 2) through the first power management module 188-1, and the second voltage may be lower than the first voltage.

The operating method according to an embodiment may further include, if the at least one processor 120 receives the interrupt, determining power failure of the display module 160. The operating method according to an embodiment may further include controlling the display module 160 to output power status information of the display module 160 on a screen. The electronic device 101 (FIG. 1) according to an embodiment may further include memory 130 (FIG. 1) operatively connected to the at least one processor 120. The operating method according to an embodiment may further include storing, in the memory 130, a time at which the interrupt generates in a diagnostic mode in which the first mode is switched to the second mode.

The operating method according to an embodiment may further include recording a usage time of the electronic device 101 in the memory 130. The operating method according to an embodiment may further include automatically executing the diagnostic mode, if the usage time exceeds a predefined time.

The operating method according to an embodiment may further include executing the diagnostic mode, if receiving a command requesting a diagnostic from a user.

The electronic device 101 (FIG. 1) according to an embodiment may further include a communication module 190 (FIG. 1) for communicating with an external device 102 or 104 or server 108 of FIG. 1 over a network. The operating method according to an embodiment may further include, if receiving the interrupt, transmitting data stored in the memory 130 to the external device 102 or 104 or server 108 of FIG. 1 over the network.

The predefined time according to an embodiment may be set differently for each region of the electronic device 101.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
at least one processor;
memory, comprising one or more storage media, storing instructions;
a display module;
a first power management module for controlling a first voltage power supply and a second voltage power supply provided to the display module; and
a second power management module comprising a regulator power supply, and controlling power supplied to the at least one processor,
wherein the instructions, when executed by the at least one processor individually or collectively, cause the electronic device to:
while the first voltage power supply is turned on, switch a first mode in which the regulator power supply is operating to a second mode in which the regulator power supply operates as a bypass,
receive an interrupt generated based on a first voltage outputted by the first voltage power supply, and
determine an abnormality of the display module based on the interrupt.

2. The electronic device of claim 1, further comprising:
a connector comprising a plurality of pins to electrically connect the display module and the first power management module,
wherein the first voltage power supply and the second voltage power supply provide power to the display module at positions of adjacent pins among the plurality of pins, and
wherein the first power management module generates the interrupt, if the first voltage falls below a reference voltage due to a short circuit occurring between the first voltage power supply and the second voltage power supply.

3. The electronic device of claim 1,
wherein the instructions that, when executed by the at least one processor individually or collectively, further cause the electronic device to: receive the interrupt from the first power management module, and
wherein the interrupt is short circuit protection (SCP) provided by the first power management module.

4. The electronic device of claim 1,
wherein the first voltage power supply is ELA VDD for providing a first voltage which is an input power to a power generation circuit through the first power management module, and
wherein the second voltage power supply is VCI for providing a second voltage which is a driving power supply to a display driver integrated circuit (IC) through the first power management module, and the second voltage is lower than the first voltage.

5. The electronic device of claim 2,
wherein the instructions that, when executed by the at least one processor individually or collectively, further cause the electronic device to, if receiving the interrupt, determine power failure of the display module, and
wherein the instructions that, when executed by the at least one processor individually or collectively, further cause the electronic device to, if receiving the interrupt, control the display module to output power status information of the display module on a screen.

6. The electronic device of claim 1, wherein the memory stores a time at which the interrupt generates in a diagnostic mode in which the first mode is switched to the second mode.

7. The electronic device of claim 6,
wherein the instructions that, when executed by the at least one processor individually or collectively, further cause the memory to record a usage time of the electronic device, and
wherein the instructions that, when executed by the at least one processor individually or collectively, further cause the electronic device to automatically execute the diagnostic mode, if the usage time exceeds a predefined time.

8. The electronic device of claim 6, wherein the instructions that, when executed by the at least one processor further cause the electronic device to execute the diagnostic mode, if receiving a command requesting a diagnostic from a user.

9. The electronic device of claim 6, further comprising:
a communication module for communicating with an external device over a network,
wherein the instructions that, when executed by the at least one processor further cause the electronic device to, if receiving the interrupt, transmit data stored in the memory to the external device over the network.

10. The electronic device of claim 7, wherein the predefined time is set differently for each region of the electronic device.

11. An operating method of an electronic device which comprises a display module, a first power management module, a second power management module and at least one processor, the operating method comprising:
while a first voltage power supply controlled by the first power management module is turned on, switching a first mode in which a regulator power supply of the second power management module is operating to a second mode in which the regulator power supply is operating as a bypass;
receiving, at the at least one processor, an interrupt generated based on a first voltage outputted by the first voltage power supply; and
determining an abnormality of the display module based on the interrupt.

12. The operating method of claim 11,
wherein the electronic device further comprises a connector comprising a plurality of pins to electrically connect the display module and the first power management module,
wherein the first voltage power supply and a second voltage power supply provide power to the display module at positions of adjacent pins among the plurality of pins, and
wherein the method further comprises generating, at the first power management module, the interrupt, if the first voltage falls below a reference voltage due to a short circuit occurring between the first voltage power supply and the second voltage power supply.

13. The operating method of claim 11, further comprising:
receiving, at the at least one processor, the interrupt from the first power management module,
wherein the interrupt is short circuit protection (SCP) provided by the first power management module.

14. The operating method of claim 12,
wherein the first voltage power supply is ELA VDD for providing a first voltage which is an input power to a power generation circuit through the first power management module, and
wherein the second voltage power supply is VCI for providing a second voltage which is a driving power supply to a display driver integrated circuit (IC) through the first power management module, and the second voltage is lower than the first voltage.

15. The operating method of claim 12, further comprising:
if the at least one processor receives the interrupt, determining power failure of the display module; and
controlling the display module to output power status information of the display module on a screen.

16. The operating method of claim 11, further comprising storing a time at which the interrupt generates in a diagnostic mode in which the first mode is switched to the second mode.

17. The operating method of claim 16, further comprising:
recording a usage time of the electronic device, and
automatically executing the diagnostic mode, if the usage time exceeds a predefined time.

18. The operating method of claim 16, further comprising executing the diagnostic mode, if receiving a command requesting a diagnostic from a user.

19. One or more non-transitory computer-readable storage media storing one or more computer programs including computer-executable instructions that, when executed by one or more processors of an electronic device individually or collectively, cause the electronic device to perform operations, the operations comprising:
while a first voltage power supply controlled by a first power management module is turned on, switching a first mode in which a regulator power supply of a second power management module is operating to a second mode in which the regulator power supply is operating as a bypass;
receiving, at the one or more processors, an interrupt generated based on a first voltage outputted by the first voltage power supply; and
determining an abnormality of a display module based on the interrupt.

20. The one or more non-transitory computer-readable storage media of claim 19, the operations further comprising:
receiving, at the one or more processors, the interrupt from the first power management module,
wherein the interrupt is short circuit protection (SCP) provided by the first power management module.
